(19) United States
(12) Patent Application Publication
(10) Pub. No.: US 2025/0077717 A1
(43) Pub. Date: Mar. 6, 2025

(54) RADIO FREQUENCY COVER REMOVAL DETECTION

(71) Applicant: Hewlett-Packard Development Company, L.P., Spring, TX (US)

(72) Inventors: Xin-Chang Chen, Taipei City (TW); He-Di Liu, Taipei City (TW); Hsin-Chih Lin, Taipei City (TW); Ming Hsuan Hsieh, Taipei City (TW)

(73) Assignee: Hewlett-Packard Development Company, L.P., Spring, TX (US)

(21) Appl. No.: 18/461,804

(22) Filed: Sep. 6, 2023

(51) Int. Cl. G06F 21/86; H04B 17/309

(52) U.S. Cl. CPC G06F 21/86; H04B 17/346

(57) ABSTRACT

A radio frequency (RF) tamper detector of an electronic device can offer improved chassis intrusion monitoring to protect the device from software and hardware-based tampering. The tamper detector can monitor RF noise levels in a first frequency band and in a second frequency band to calculate an RF noise level moving average for each frequency band. If the moving averages in both frequency bands exceed a RF noise threshold, the tamper detector can set a cover removal flag to indicate that a cover of the device housing has been removed. The tamper detector can cause the electronic device to lock or disable a system BIOS when cover removal is detected. Additionally, the electronic device can notify remote monitoring systems (e.g., operated by an IT administrator or warranty support center) to receive additional instructions to secure the device.

### BACKGROUND

Generally described, computing devices or electronic devices can be configured with tamper detection and other anti-tamper features to prevent unauthorized access. Examples of electronic devices include, but are not limited to, mobile phones, tablets, base stations, network access points, customer-premises equipment (CPE), notebook or desktop computers, cameras, and wearable electronics.

### BRIEF DESCRIPTION OF THE DRAWINGS

FIGS. 1A and 1B are schematic representations of examples of an electronic device implementing a cover removal detector;

FIG. 2A is a schematic representation of one example of a radio frequency (RF) cover removal detector according to FIG. 1B;

FIG. 2B is a schematic representation of another example of the RF cover removal detector of FIG. 1B;

FIG. 2C is a schematic representation of an additional example of a RF cover removal detector;

FIG. 3 illustrates an example of radio frequency (RF) noise sampled by a RF cover removal detector;

FIG. 4 illustrates a method for RF cover removal detection;

FIG. 5 illustrates an example of remote monitoring for the electronic device of FIG. 1B; and

FIG. 6 illustrates how RF cover removal detectors can interact with one or more remote monitoring systems according to FIG. 5.

### DETAILED DESCRIPTION

Electronic devices may be subject to tampering from unauthorized users attempting to access sensitive data or modify a hardware or software configuration of the device. In one example of tampering, a user may damage the electronic device while trying to open the device without appropriate training. In another example, an attacker may open the device to install unauthorized hardware components (e.g., a network interface) or flash unsigned firmware designed to exploit the device. A low-level exploit can be used to gain control of the electronic device invisibly underneath the operating system, which the attacker could leverage to further exploit a network of connected devices.

Accordingly, electronic devices can be provided with one or more layers of tamper detection or anti-tamper features to provide a secure operating environment. Examples of such features include tamper-evident stickers, security fasteners, chassis intrusion sensors, serialized hardware components, basic input-output system (BIOS) checksums, event logging, and remote monitoring.

Cover removal detection (also referred to as intrusion monitoring or chassis intrusion sensing) is a form of tamper detection which can discourage a user from opening a housing of the electronic device. In some cases, tamper detection can protect against fraudulent warranty claims, or prevent an attacker from modifying the device.

Examples described herein provide a radio frequency (RF) tamper detector for improved chassis intrusion monitoring of an electronic device. The tamper detector can monitor RF noise levels in a first frequency band and in a second frequency band to calculate a noise level moving average for each frequency band. If the moving averages in both frequency bands exceed a RF noise threshold, indicating that a housing of the device has been removed (i.e., is no longer attenuating ambient RF noise entering the device), the tamper detector can set a cover removal flag to indicate that tampering has occurred. The tamper detector can cause the electronic device to lock or disable a system BIOS when cover removal is detected. Additionally, the electronic device can notify remote monitoring systems (e.g., via a server operated by an IT administrator or warranty support center) to receive additional instructions to secure the device.

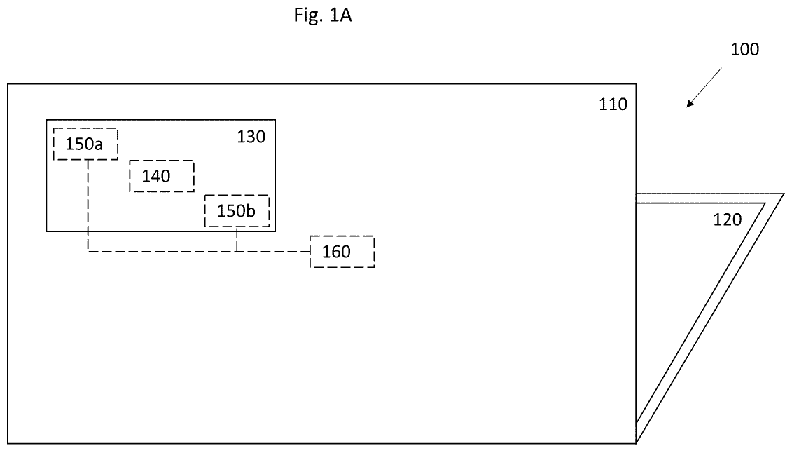

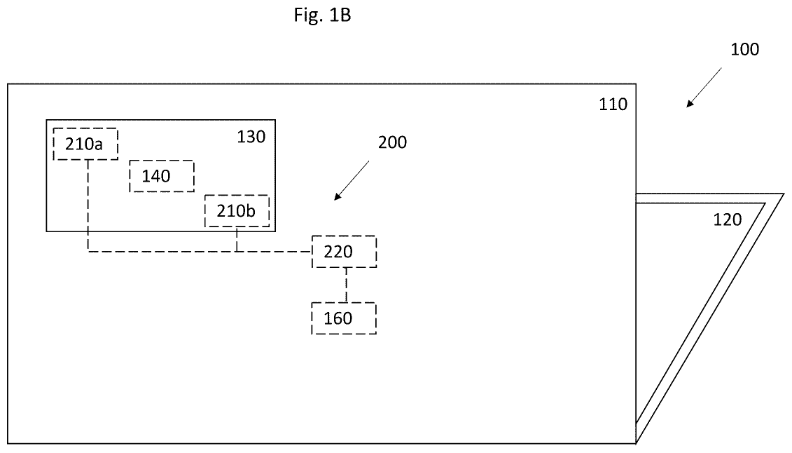

Referring initially to FIGS. 1A-1B, examples of an electronic device implementing a cover removal detector are schematically illustrated. The electronic device is a notebook computer 100 comprising a housing 110 and a display portion 120. The housing 110 is in a folding configuration, and protects sensitive internal hardware of the notebook computer 100 from physical damage as well as tampering. The housing 110 includes one or more removable covers 130 which each shield an opening in the housing for accessing the internal hardware components. The removable cover(s) 130 can be located in various areas of the housing 110 according to the internal construction of the device, such as on an underside of the notebook computer 100 (illustrated by FIGS. 1A-1B), along an edge of the housing 110, underneath a computer keyboard, or behind the display portion 120. The removable cover(s) 130 are each monitored by the cover removal detector to prohibit unauthorized access to the internal hardware components of the notebook computer 100.

A hardware component 140 of the notebook computer 100 is installed underneath the removable cover 130. Examples of a hardware component 140 include processors (e.g., a central processor, embedded controller, cryptographic processor, or coprocessor), non-transitory storage media (e.g., memory and storage devices), and interface devices (e.g., a network interface card, serial or parallel devices, and display or audio interfaces), although the hardware component 140 can include any computer hardware component known to those skilled in the art.

In the example of FIG. 1A, a pair of cover removal sensors 150 are provided underneath the removable cover 130, each of the sensors being in communication with an embedded controller 160 to trigger cover removal detection when the cover 130 is removed. Accordingly, if any attempt is made to modify the hardware component 140 of the notebook computer 100, the cover removal detector will record the cover removal event for later review and analysis.

In certain examples, at least one of the cover removal sensors 150 can be a pressure-sensitive mechanical switch. The switch(es) contact the cover 130 from the inside of the housing 110 such that the switch(es) are depressed when the cover 130 is fully installed. The embedded controller 160 can detect a closed circuit formed by each of the depressed switches and update a cover removal detection state when the circuit is broken.

As will be discussed herein, the cover removal sensors 150 can further include one or more RF antennas for wireless cover removal detection. Wireless sensing can offer several security advantages over a purely mechanical system. For example, a radio frequency cover removal detector cannot be bypassed by destructively removing the device housing 110 or the removable cover 130.

FIG. 1B shows an example of the electronic device implementing a RF cover removal detector 200. The hardware component 140 of the notebook computer 100 is installed underneath the removable cover 130. The cover removal sensors 150 are pair of RF receive (RX) antennas 210a and 210b provided underneath the removable cover 130 such than an ambient RF noise level at each of the antennas is reduced when the cover is installed. The embedded controller 160 is communicatively connected to each of the RX antennas 210a and 210b via a RF module 220, which provides signal conditioning and filtering. The embedded controller 160 is to iteratively sample RF noise levels at each of the RX antennas 210a and 210b in order to trigger the cover removal detection when the cover 130 is removed (i.e., the RF noise levels exceed a detection threshold). Accordingly, if any attempt is made to modify the hardware component 140 of the notebook computer 100, the RF cover removal detector 200 will record the cover removal event for later review and analysis.

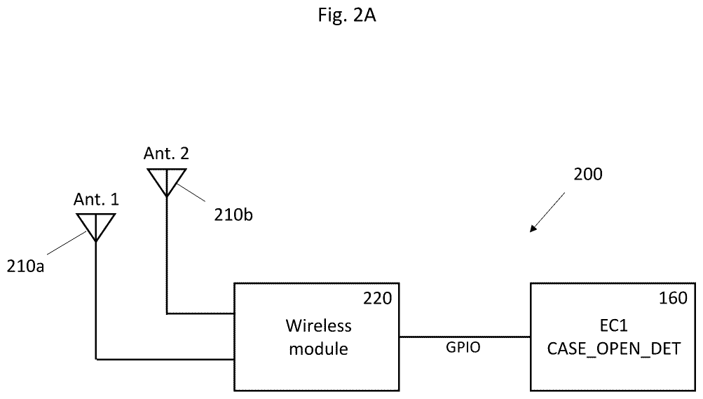

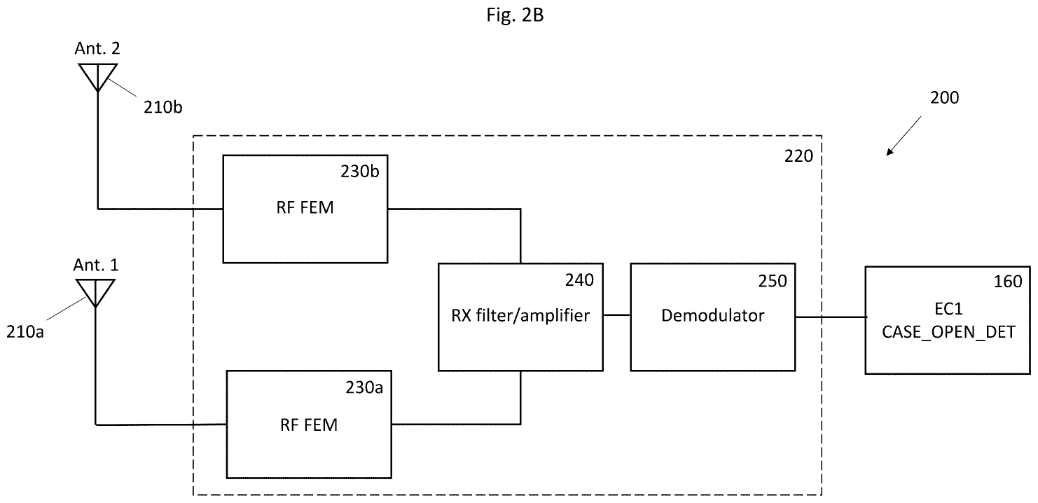

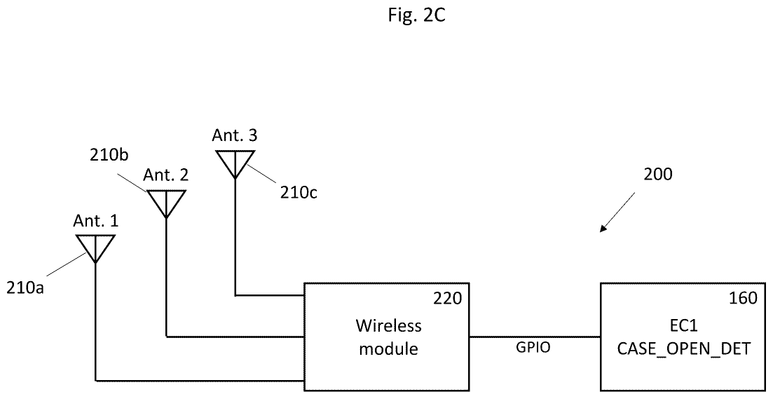

Referring now to FIGS. 2A-2C, examples of a radio frequency (RF) cover removal detector 200 (also referred to as wireless noise tamper detector) are schematically illustrated. The RF cover removal detector 200 uses wireless hardware of an electronic device alternatively, or in addition to, mechanical switches to detect and update a cover removal state of the detector. The RF cover removal detector 200 uses the RF module 220 (also referred to as a wireless module) including a radio frequency front-end module (RF FEM) 230 to receive RF signals in at least a first frequency band and a second frequency band.

As illustrated in FIG. 2B, the RF module 220 can further include a pair of RF FEMs 230a and 230b corresponding to each frequency band. As illustrated, the RF module 220 is communicatively connected to the pair of RX antennas 210a and 210b for receiving RF signals in the corresponding first frequency band and second frequency band. The RF module 220 includes a receive filter amplifier stage 240 (e.g., one or more low-noise amplifiers and RF filters) connected to the RF FEM(s) 230, and can be further combined with a demodulator stage 250 provide an amplified, demodulated signal output of the RF module 220. The embedded controller 160 is communicatively connected to the signal output of the RF module 220, such as by an analog or a digital interface (e.g., general-purpose input/output).

In some cases, the RF cover removal detector 200 is to receive RF signals in three or more frequency bands. FIG. 2C illustrates the RF module 220 communicatively connected to a first, second, and third RX antenna (210a-210c) for receiving low band, mid-band, and high band signals, respectively. It will be appreciated that band coverage of the RF cover removal detector 200 is not necessarily a 1:1 correspondence with the number of RX antennas 210. In certain cases, one or more of the RX antennas 210 are capable of multi-band receiving. For example, the pair of RX antennas 210a and 210b of FIG. 2B can each be dual-band antennas, allowing the RF cover removal detector 200 to receive RF signals in four separate frequency bands. The wireless module 220 can receive and process RF signals in various frequency bands using a plurality of RF FEMs 230, receive filter amplifier stages 240, and demodulator stages 250 corresponding to the respective frequency bands.

In other embodiments, multiple antennas are to receive RF signals in a single frequency band. Although FIGS. 2A and 2C are described as examples having different numbers of antennas and frequency bands, similar techniques can be applied to any number of antennas and any number of frequency bands for detecting cover removal. Further, although in some examples described herein, cover removal is detected (e.g., cover removal flag is set) when the RF signals from all of the frequency bands satisfy the threshold(s) (e.g., cover removal threshold), in other embodiments, cover removal is detected when the RF signals from a threshold number or percentage of the frequency bands satisfy those threshold(s) (e.g., 3 out of 4 frequency bands monitored, or 75% of all frequency bands monitored).

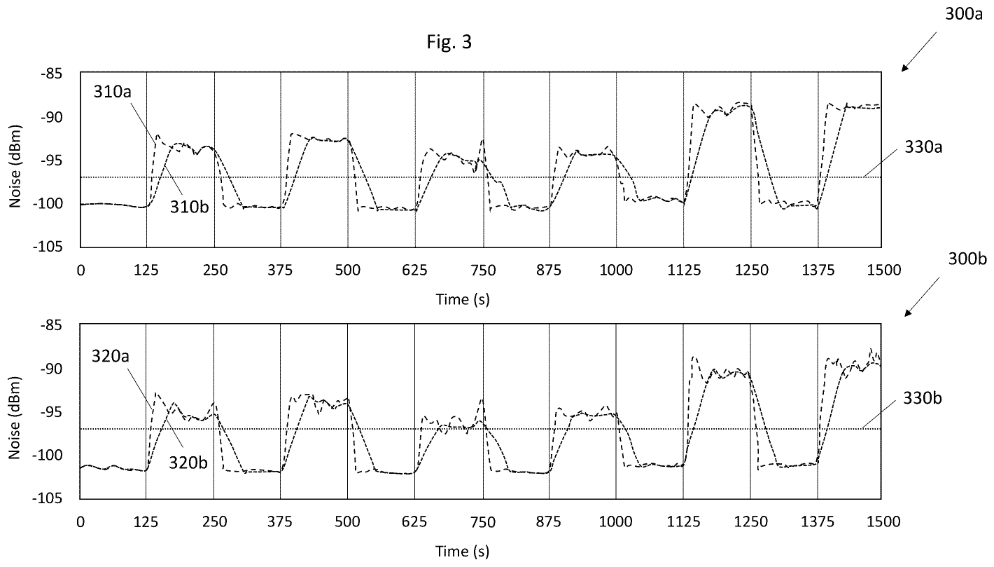

FIG. 3 illustrates an example of RF noise sampled by the RF cover removal detector 200 of FIGS. 2A-2C. As will be appreciated by those skilled in the art, the housing 110 of the electronic device (and by extension, the removable cover 130) can attenuate RF signals transmitted and received by the device. In addition to physical protection, the housing 110 and the removable cover 130 serve to protect the device from RF noise in the ambient environment which can cause electromagnetic interference. The RF cover removal detector 200 benefits from the fact that RF noise level measurements inside the electronic device will tend to be lower when the removable cover 130 is properly installed (enclosing the RX antennas 210a and 210b within the housing 110) compared to when the cover 130 is removed, allowing ambient RF noise to pass directly inside the device with little attenuation. Accordingly, the embedded controller 160 can compute a first moving average of the RF noise levels in the first frequency band and a second moving average of the RF noise levels in the second frequency band to determine if both moving averages exceed a noise threshold indicating that the cover 130 has been removed.

Graph 300a and graph 300b illustrate moving averages of RF noise captured by each one of the pair of RX antennas 210a and 210b as the removable cover 130 is removed or installed at intervals of 125 seconds. The graph 300a corresponds to the first frequency band (e.g., a low frequency band) and the graph 300b corresponds to the second frequency band (e.g., a high frequency band). In the example of FIG. 3, the low frequency band is centered at approximately 860 MHz and the high frequency band is centered at approximately 875 MHz, corresponding to a subset of Long-Term Evolution (LTE) band 18. The first frequency band and the second frequency band can comprise a subset of LTE frequency bands, 5G New Radio (NR) frequency bands, Wi-Fi frequency bands, and/or Bluetooth Low Energy (BLE) frequency bands. Advantageously, the RF cover removal detector 200 can be implemented with existing wireless hardware of an electronic device capable of sampling frequency bands of one or more wireless connectivity standards.

The embedded controller 160 iteratively samples a plurality of instantaneous RF noise levels in the first frequency band and a plurality of instantaneous RF noise levels in the second frequency band (collectively referred to as RF noise samples) at a predetermined sampling frequency. Once the plurality of RF noise samples meet a minimum sample size (or when a corresponding waiting period has elapsed), the controller 160 begins to iteratively compute a first moving average 310 and a second moving average 320 from a most recently sampled subset of the plurality of RF noise samples. The minimum sample size and a sampling window (also referred to as a noise profiling duration) are used to determine the most recently sampled subset of the plurality of RF noise samples used to compute the moving averages. For example, with a sampling window of X seconds, the embedded controller 160 will use a subset of the plurality of RF noise samples of the first frequency band which have been acquired in the previous X seconds in computing the first moving average 310, and the embedded controller 160 will use a subset of the plurality of RF noise samples of the second frequency band which have been acquired in the previous X seconds in computing the second moving average 320. (As will be discussed herein, the embedded controller 160 can also use different sampling windows in computing the first moving average 310 and the second moving average 320.) Meanwhile, the embedded controller 160 continues to iteratively sample the instantaneous RF noise levels to compute an updated first moving average 310 and an updated second moving average 320 at the predetermined sampling frequency.

FIG. 3 illustrates relative change in the first moving average 310 and the second moving average 320 as the cover 130 is iteratively removed from the housing 110 and replaced. In a first interval from 0 to 125 seconds, the cover is installed, and average noise remains below about −100 dBm in the first frequency band and the second frequency band. In a second interval from 125 to 250 seconds, the cover is removed, and both the first moving average 310 and the second moving average 320 rise over the span of several seconds to approximately −95 dBm, exceeding a cover removal threshold 330 (also referred to as a noise threshold). Every 125 seconds, the process of installing or removing the cover 130 is repeated to demonstrate the effects of ambient RF noise on both moving averages.

The graph 300a compares two examples of the first moving average 310 computed for which the sampling window was a 30 second duration (first moving average 310a) or a 100 second duration (first moving average 310b). The graph 300b also shows a comparison of two examples of the second moving average 320 computed for which the sampling window was a 30 second duration (second moving average 320a) or a 100 second duration (second moving average 320b). It will be appreciated that a longer sampling window results in a moving average which rises and decays more slowly, which can be beneficial in preventing false positive detections by the RF cover removal detector 200.

The embedded controller 160 can also compute the first moving average 310 and the second moving average 320 using two different sampling windows which better correspond to a noise profile of the first and second frequency bands. For example, where the second frequency band may have a more erratic noise profile, the embedded controller 160 can compute the first moving average over a shorter sampling window (e.g., 10, 30, or 60 seconds) and compute the second moving average over a relatively longer sampling window (e.g., 90, 100, or 120 seconds) to provide a smoother moving average.

When the embedded controller 160 determines that the first moving average 310 and the second moving average 320 both exceed the cover removal threshold 330, the controller 160 can set a cover removal variable (also referred to as a cover removal flag or Boolean), to indicate that the cover 130 of the housing 110 has been removed. The cover removal threshold 330 can be the same in both frequency bands (as in FIG. 3), or the embedded controller 160 can apply a different cover removal threshold in each frequency band based on the ambient RF noise levels. The cover removal threshold 330 can be a predetermined threshold based on a factory configuration of the RF cover removal detector 200, or adjustable by performing calibration on the electronic device in the field.

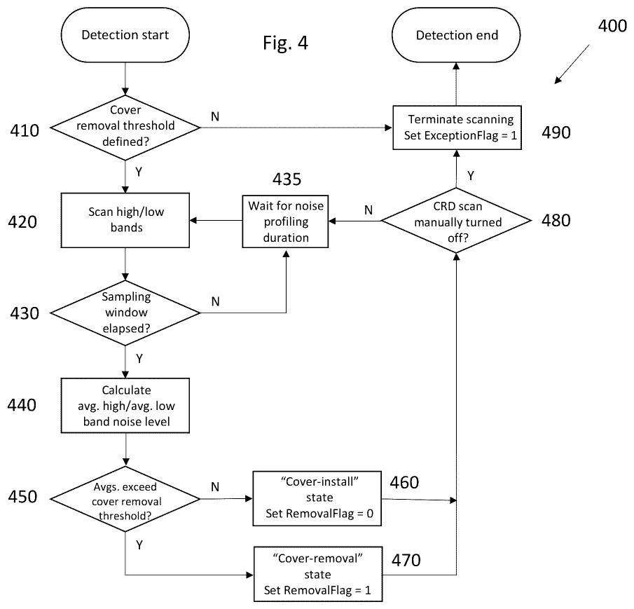

Referring now to FIG. 4, method 400 for cover removal detection according to the RF cover removal detector 200 is shown.

When cover removal detection (CRD) is initialized, such as at the first boot of the electronic device, a processor (e.g., the embedded controller 160) checks whether the cover removal threshold 330 is defined at block 410. The cover removal threshold 330 can be stored in non-volatile memory (such as RAM or ROM) and/or accessed from one or more storage media connected to the device. If the cover removal threshold 330 is not predefined based on a factory configuration of the device, or the user has not performed calibration to set the threshold, the method 400 can proceed to block 490 and terminate CRD while setting an exception variable indicating that the method could not proceed.

If the cover removal threshold 330 is defined, the method 400 can advance to block 420, wherein the RF module 220 scans the first and second frequency bands to measure a plurality of RF noise level samples. In one example, the RF module 220 can measure, at a first time, a first instantaneous RF noise level in the first frequency band and a first instantaneous RF noise level in the second frequency band and measure, at a second time, a second instantaneous RF noise level in the first frequency band and a second instantaneous RF noise level in the second frequency band. The RF module 220 can iteratively measure instantaneous RF noise levels in the first frequency band and in the second frequency band at the predetermined sampling frequency until a sample limit is reached or the CRD scan is terminated.

At block 430, the processor checks whether the duration of the sampling window for computing the moving averages 310 and 320 has elapsed since the start of scanning. If the time elapsed is less than the sampling window (meaning that the number of RF noise level measurements is less than the minimum sample size based on the predetermined sampling frequency), the method 400 waits at block 435 for the full sampling window to proceed. The sampling window (also referred to as the noise profiling duration) is greater than a period of the predetermined sampling frequency to ensure that two or more RF noise level measurements in each frequency band are available to calculate the moving averages.

At block 440, the processor computes the first moving average 310 of the RF noise level in the first frequency band and the second moving average 320 of the RF noise level in the second frequency band. The processor can also iteratively compute the first moving average 310 and the second moving average 320 based on the plurality of instantaneous RF noise level measurements recently sampled within the sampling window. In some cases, the processor can iteratively compute the first moving average 310 based on a plurality of instantaneous RF noise level measurements in the first frequency band recently sampled within a first noise profiling duration (e.g., 30 seconds), and iteratively compute the second moving average 320 based on a plurality of instantaneous RF noise level measurements in the second frequency band recently sampled within a second noise profiling duration (e.g., 100 seconds). In some cases, the first frequency band can be a low frequency band and the second frequency band can be a high frequency band, wherein the first noise profiling duration is less than the second noise profiling duration. The first frequency band and the second frequency band can also comprise a subset of LTE frequency bands, 5G NR frequency bands, Wi-Fi frequency bands, and/or BLE frequency bands.

At block 450, the method 400 compares the first moving average 310 and the second moving average 320 to one or more cover removal thresholds 330 (RF noise thresholds). The processor determines whether the first moving average 310 and the second moving average 320 both exceed the cover removal threshold 330 for the corresponding frequency bands. Based on the outcome of the determination, the method proceeds to either block 460 or block 470.

At block 460, responsive to a determination that the first moving average 310 does not exceed a first cover removal threshold 330a or the second moving average 320 does not exceed a second cover removal threshold 330b, the processor can reset or clear the cover removal variable to indicate that the cover 130 of the housing 110 is presently installed.

At block 470, responsive to a determination that the first moving average 310 exceeds the first cover removal threshold 330a and the second moving average 320 exceeds a second cover removal threshold 330b, the processor can set the cover removal variable to indicate that the cover 130 of the housing 110 has been removed, and tampering has occurred.

Once the cover removal variable is updated, the method 400 proceeds to block 480, where the processor checks if the electronic device has received user input (e.g., an administrative command) to shut down cover removal detection. The method then returns to block 435 to proceed with scanning by the RF module 220, or exits to block 490 to set the exception variable if CRD is terminated.

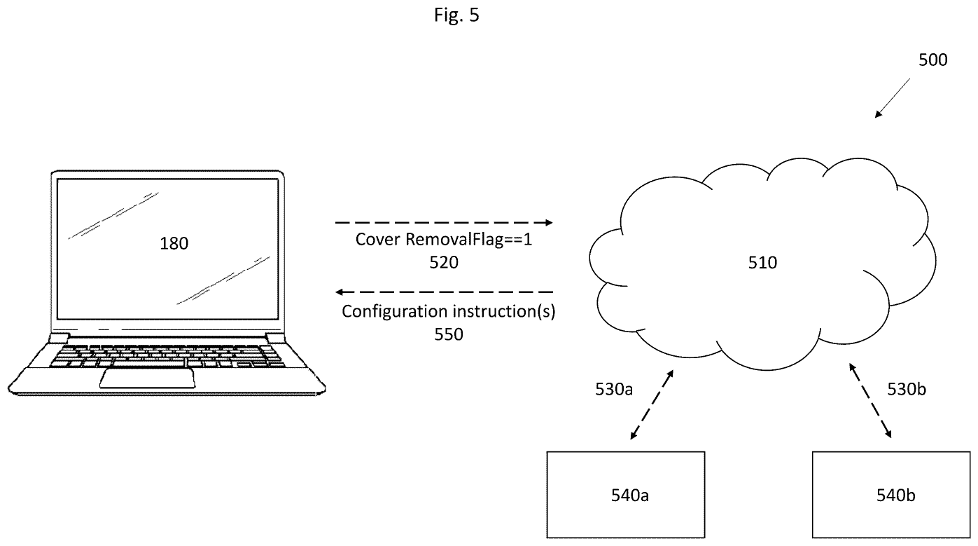

When the cover removal variable is set and tampering is detected, the electronic device can take additional steps to prevent unauthorized access. FIG. 5 illustrates one example of remote monitoring 500 of an electronic device (the notebook computer 100) by a remote server 510 (e.g., a cloud server). The processor of the device can lock a hardware controller or a basic input-output system (BIOS) of the device responsive to the cover removal variable indicating that the cover 130 of the housing 110 has been removed. The locked hardware controller or BIOS can prevent additional hardware devices from being installed in the electronic device or modifying the BIOS firmware, which could be used to load malware or defeat security measures.

A network interface (one example of the hardware component 140) of the electronic device can also be used to transmit a notification 520 or alert to a remote monitoring system of the remote server 510 responsive to the cover removal variable indicating that the cover of the housing has been removed. Such a network interface can use the RF module 220 to transmit the notification 520 over one or more wireless communication standards (e.g., Wi-Fi, LTE, 5G NR, or Bluetooth) to the remote server 510. In some cases, the network interface is a wired interface and may communicate with the remote server 510 by a wired connection. The notification 520 transmitted to the remote server 510 indicates that the cover removal variable has been set, but can further include useful information such as a device serial number, internet protocol (IP) address, location information, and hardware and software version information.

The electronic device can further determine a connectivity status of the network interface. Responsive to a determination that the network interface is offline (i.e., connection cannot be established with the remote server 510), the notification 520 can be stored in a transmission queue until network connectivity is reestablished. In some cases, network packets can be queued by importance, and the notification 520 receives priority in the queue so it can be urgently transmitted. Upon determining that connection to the remote server 510 is restored, the network interface transmits the notification to the remote monitoring system.

When the remote monitoring system of the remote server 510 receives the notification 520 from the electronic device, the server 510 can transmit alert(s) 530 to one or more user devices 540. The alert 530 can include the information received in the notification 520, as well as contextual information available to the remote server 510 such as ownership of the device and warranty support eligibility. The server 510 receives user input from an administrative user via one of the one or more user devices 540, and the remote monitoring system transmits configuration instructions 550 to the electronic device according to the user input. The configuration instructions 550 can comprise instructions to lock, disable, or erase one or more hardware or software components of the electronic device. For example, the processor can set one or more storage media of the electronic device to read-only, or delete the contents of the storage media entirely.

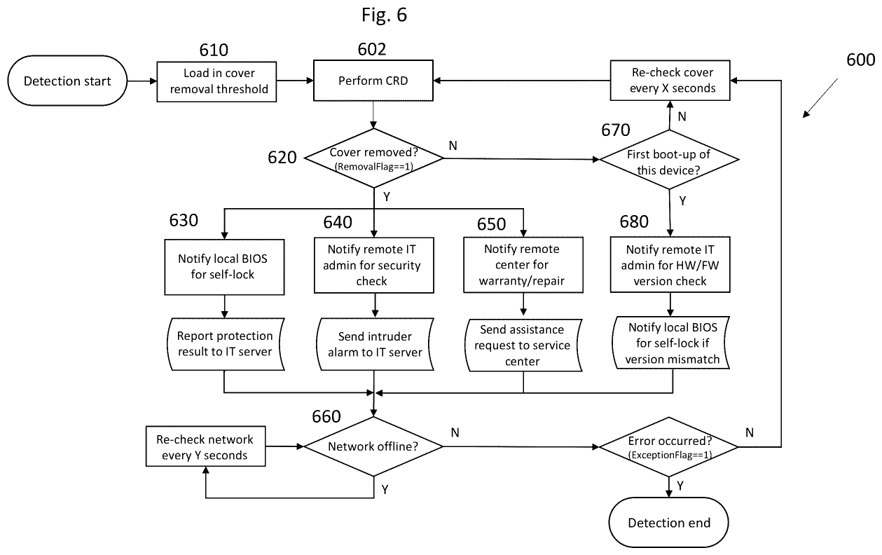

FIG. 6 illustrates how the RF cover removal detector 200 can interact with one or more remote monitoring systems according to FIG. 5. At block 610, the device can load in the cover removal threshold 330. For example, the processor can access the storage media or load in the cover removal threshold 330 directly from RAM or ROM. At block 602, the RF cover removal detector 200 performs cover removal detection (e.g., the cover removal detection method illustrated in FIG. 4).

At block 620, the processor checks whether the cover removal variable is set. If the variable is set, indicating that the cover 130 is removed from the housing 110, the processor can transmit several notifications 520 to different remote monitoring systems.

At block 630, the processor notifies the local BIOS of the electronic device to lock down so that an attacker cannot install modified firmware. At block 640, the processor can transmit the notification 520 to an IT monitoring system of the remote server 510 via the network interface (e.g., hardware component 140) to alert an IT administrator. At block 650, the processor can further transmit the notification 520 to a warranty repair monitoring system of the remote server 510 via the network interface to initiate a service request. At block 660, if the processor determines that the network interface is offline and cannot transmit the notification 520, the notification will be entered into the transmission queue and transmitted after re-checking network connectivity periodically.

If the cover removal variable is not set, at block 670 the processor identifies if this is the first boot-up of the electronic device. For regular boot-ups, the processor can return to performing cover removal detection at block 602. However, for the initial booting of the device at block 680, the processor performs a validation to notify the IT administrator via the remote server 510 if an invalid hardware and software configuration is present. The processor can identify a serial number of one or more hardware components of the electronic device (e.g., the processor and one or more interface cards), identify a version number of one or more software component of the electronic device (e.g., the BIOS and operating system), and compare the serial number(s) and the version number(s) to validate a correspondence. The processor can reference a hardware-software whitelist to validate the correspondence. In some cases, the correspondence may be determined cryptographically. The serial number(s) and the version number(s) may also be transmitted to the remote server 510 to receive an authentication token indicating that the device is allowed to boot. If the event of an invalid correspondence (indicating that hardware or software have been modified), the processor can set the detection variable to indicate that the cover 130 of the housing 110 has been removed, to lock down the local BIOS and notify the remote server 510.

The principles of the examples described herein can be used for any other system or apparatus including mobile phones, tablets, base stations, network access points, customer-premises equipment (CPE), laptops, cameras, and wearable electronics.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled,” as generally used herein, refers to two or more elements that can be either directly connected, or connected by way of one or more intermediate elements. Likewise, the word “connected,” as generally used herein, refers to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “may,” “could,” “might,” “can,” “e.g.,” “for example,” “such as” and the like, unless specifically stated otherwise, or otherwise understood within the context as used, is generally intended to convey that certain examples include, while other examples do not include, certain features, elements and/or states. Thus, such conditional language is not generally intended to imply that features, elements and/or states are in any way required for one or more examples or that one or more examples necessarily include logic for deciding, with or without author input or prompting, whether these features, elements and/or states are included or are to be performed in any particular example.

What is claimed is:

1. An electronic device comprising:
a housing including a removable cover;
a radio frequency (RF) module to:
measure, at a first time, a first instantaneous RF noise level in a first frequency band and a first instantaneous RF noise level in a second frequency band;
measure, at a second time, a second instantaneous RF noise level in the first frequency band and a second instantaneous RF noise level in the second frequency band; and
a processor to:
compute a moving average of the RF noise levels in the first frequency band and a moving average of the RF noise levels in the second frequency band;
responsive to a determination that the moving average of the RF noise levels in the first frequency band exceeds a first noise threshold and the moving average of the RF noise levels in the second frequency band exceeds a second noise threshold, set a cover removal variable to indicate that the cover of the housing has been removed; and
responsive to a determination that the moving average of the RF noise levels in the first frequency band does not exceed the first noise threshold or the moving average of the RF noise levels in the second frequency band does not exceed the second noise threshold, reset the cover removal variable to indicate that the cover of the housing is presently installed.

2. The electronic device of claim 1, wherein computing the moving average of the RF noise level in the first frequency band and the moving average of the RF noise level in the second frequency band comprises:
iteratively measuring instantaneous RF noise levels in the first frequency band and in the second frequency band at a noise sampling frequency; and
iteratively computing the moving average of the RF noise levels in the first frequency band and the moving average of the RF noise levels in the second frequency band based on a plurality of instantaneous RF noise level measurements recently sampled within a noise profiling duration.

3. The electronic device of claim 2, wherein the noise profiling duration is greater than a period of the noise sampling frequency.

4. The electronic device of claim 2, wherein iteratively computing the moving averages of the RF noise levels further comprises:
iteratively computing the moving average of the RF noise levels in the first frequency band based on a plurality of instantaneous RF noise level measurements in the first frequency band recently sampled within a first noise profiling duration; and
iteratively computing the moving average of the RF noise levels in the second frequency band based on a plurality of instantaneous RF noise level measurements in the second frequency band recently sampled within a second noise profiling duration.

5. The electronic device of claim 4, wherein the first frequency band is a low frequency band and the second frequency band is a high frequency band, and wherein the first noise profiling duration is less than the second noise profiling duration.

6. The electronic device of claim 4, wherein the first frequency band and the second frequency band comprise a subset of Long-Term Evolution (LTE) frequency bands, 5G New Radio (NR) frequency bands, Wi-Fi frequency bands, and/or Bluetooth Low Energy (BLE) frequency bands.

7. The electronic device of claim 1, wherein the processor is to lock a hardware controller or a basic input-output system (BIOS) of the device responsive to the cover removal variable indicating that the cover of the housing has been removed.

8. The electronic device of claim 1, wherein a network interface of the device is to transmit a notification to a remote monitoring system responsive to the cover removal variable indicating that the cover of the housing has been removed.

9. The electronic device of claim 8, wherein transmitting the notification to the remote monitoring system comprises:
determining a connectivity status of the network interface;
responsive to a determination that the network interface is offline, queuing the notification until network connectivity can be reestablished; and
transmitting, by the network interface, the notification to the remote monitoring system.

10. The electronic device of claim 8, wherein the processor is to reset, lock, disable, or erase a hardware or a software component of the device responsive to an instruction received by the network interface from the remote monitoring system.

11. A method comprising:
iteratively sampling an instantaneous RF noise level in a first frequency band and iteratively sample an instantaneous RF noise level in a second frequency band to acquire a plurality of RF noise samples of the first frequency band and the second frequency band at an electronic device;
averaging the plurality of RF noise samples of the first frequency band to determine a first moving average;
averaging the plurality of RF noise samples of the second frequency band to determine a second moving average;
comparing the first moving average and the second moving average to a noise threshold at the electronic device;
determining that the first moving average and the second moving average both exceed the noise threshold at the electronic device; and
setting a detection variable to indicate that tampering has occurred at the electronic device.

12. The method of claim 11, wherein iteratively sampling the instantaneous RF noise level in the first frequency band and iteratively sampling the instantaneous RF noise level in the second frequency band comprises:
acquiring, over a sampling duration, a plurality of instantaneous RF noise level measurements in the first frequency band at the electronic device; and
acquiring, over the sampling duration, a plurality of instantaneous RF noise level measurements in the second frequency band at the electronic device.

13. The method of claim 12, wherein averaging the plurality of RF noise samples of the first frequency band to determine a first moving average and averaging the plurality of RF noise samples of the second frequency band to determine a second moving average comprises:
determining that the plurality of RF noise samples of the first frequency band and the plurality of RF noise samples of the second frequency band meet a minimum sample size;
computing a first moving average based on a subset of the plurality RF noise samples in the first frequency band recently sampled within a first noise profiling duration; and
computing a second moving average based on a subset of the plurality RF noise samples in the second frequency band recently sampled within a second noise profiling duration.

14. The method of claim 13, wherein the first frequency band is a low frequency band and the second frequency band is a high frequency band, and wherein the first noise profiling duration is less than the second noise profiling duration.

15. The method of claim 13, wherein the first frequency band and the second frequency band comprise a subset of Long-Term Evolution (LTE) frequency bands, 5G New Radio (NR) frequency bands, Wi-Fi frequency bands, and/or Bluetooth Low Energy (BLE) frequency bands.

16. A radio frequency (RF) cover removal detector, comprising:
a housing including a removable cover; and
a controller communicatively connected to a radio frequency module to:
iteratively measure instantaneous RF noise levels in a first frequency band and in a second frequency band at a noise sampling frequency;
iteratively compute a moving average of the RF noise levels in the first frequency band and a moving average of the RF noise levels in the second frequency band based on a plurality of instantaneous RF noise level measurements recently sampled within a noise profiling duration;
determine that the moving average of the RF noise levels in the first frequency band and the moving average of the RF noise levels in the second frequency band exceed a noise threshold;
set a detection variable to indicate that the cover of the housing has been removed; and
transmit a notification responsive to the detection variable indicating that the cover has been removed.

17. The radio frequency cover removal detector of claim 16, wherein the controller is to lock a basic input-output system (BIOS) of an electronic device responsive to the detection variable indicating that the cover has been removed.

18. The radio frequency cover removal detector of claim 17, wherein the controller is to queue the notification until network connectivity of the electronic device can be established.

19. The radio frequency cover removal detector of claim 17, wherein the controller is to lock, disable, or erase a hardware or a software component of the electronic device responsive to a remote input.

20. The radio frequency cover removal detector of claim 17, wherein the controller is to:
identify a serial number of a hardware component of the electronic device;
identify a version number of a software component of the electronic device;
compare the serial number and the version number to validate a correspondence; and
responsive to an invalid correspondence, set the detection variable to indicate that the cover of the housing has been removed.
